(19) United States
(12) Patent Application Publication
(10) Pub. No.: US 2014/0144020 A1
(43) Pub. Date: May 29, 2014

(54) DEVICE AND METHOD FOR EXPANDING TUBES

(71) Applicant: C.M.S. COSTRUZIONE MACCHINE SPECIALI S. R.L., Alonte (VI) (IT)

(72) Inventors: VINICIO MAGGIOLO, Montagnana (PD) (IT); LORIS SARTORI, Alonte (VI) (IT)

(73) Assignee: C.M.S. Costruzione Macchine Speciali S.R.L., Alonte (VI) (IT)

(21) Appl. No.: 13/686,369

(22) Filed: Nov. 27, 2012

(51) Int. Cl. B21D 41/02; B23P 15/26

(52) U.S. Cl. CPC B21D 41/028; B23P 15/26
USPC 29/890.053; 72/462; 72/393

(57) ABSTRACT

Device for expanding tubes inserted in a finned pack of a heat exchanger including support means of the finned pack, a tool for enlarging the ends of each one of the tubes, a mandrel for the radial expansion of each one of the tubes. The device also includes axial abutment means for both enlarged ends of each one of the tubes in the contraction direction of each one of the tubes during the radial expansion operation. A method for expanding tubes carried out with such a device is also proposed.

### CROSS REFERENCE TO RELATED APPLICATIONS

This application claims the benefit of priority from Italian Patent Application No. VR2011A000212 filed on Nov. 28, 2012, the contents of which are incorporated by reference.

### TECHNICAL FIELD OF THE INVENTION

The present invention concerns a device and a method for expanding tubes.

More specifically, the present invention concerns a device and a method for expanding tubes intended for making heat exchangers.

### DESCRIPTION OF RELATED ART

As known, the most common heat exchangers currently on the market, both of small and large size, consist of a bank of tubes, usually having circular section, which is inserted in a finned pack equipped with suitable holes, which represents the extended outer surface on the secondary fluid, which usually consists of air.

In order to make circuits on the tubes side, they are connected together, in their end parts, in series or in parallel in order to have passage sections and lengths most suitable for heat exchange and an acceptable load loss for the primary fluid.

In relation to the various production aspects, like for example the type of application to be made, the production costs and times, and yet more, it is possible to use rectilinear tubes or tubes already bent into a “U”, known as hairpins.

The permanent connection between the bank of tubes and the finned pack is normally made through the radial expansion of the tubes, carried out mechanically, known as expansion.

Thanks to the expansion, the connection between the bank of tubes and the finned pack is sufficiently solid and rigid, and it also makes it possible to obtain good efficiency in terms of the optimal heat exchange between the tubes and the fins.

The main technical problem connected to carrying out such an operation is the reduction of the length of the tubes after their radial expansion.

Due to this, traditionally in the field it has always been necessary to foresee an axial oversizing of the tubes by about 2-4% with respect to the final length that it is wished to obtain.

Since such oversizing, usually estimated based on empirical calculations, does not ensure a sufficient precision in the final length of the expanded tube, solutions have been devised of machines comprising clamping means that carry out the axial locking of the tube or of the hairpin, so that, during the mechanical expansion that each tube undergoes, the predetermined length of the tube itself is maintained without significant variations, or in any case entirely acceptable ones within a certain range: clearly, as a consequence of such axial locking, there will be a certain reduction in thickness of each tube, which must be foreseen in the sizing step.

It has been observed, particularly but not exclusively in applications with tubes having a small diameter and low thickness, that the use of such clamping means, which lock the end of the tube with jaws or other similar members, causes surface incisions, i.e. permanent deformations or strain hardening of material in the ends themselves that make the subsequent machining necessary to make the circuit connections of the tubes difficult or laborious.

In some cases, during the mechanical expansion step of the tubes, it becomes necessary to proceed through a first deformation of the tubes due to the action of the clamps, to counteract their shrinkage, to then redeform them bringing them back to the original dimensions, in this way allowing the enlargement mandrel to come out from the tubes. The subsequent machining of the end part of the tubes, in order to be able to make the circuit connections, is so-called socketing, i.e. a sort of flaring that allows the subsequent insertion of bends, nipples, or other necessary elements, which are fixed for example through brazing or with other equivalent techniques. If the socketing is carried out after they have been narrowed and subsequently enlarged as described above, one has to act on a material that is already strain hardened on which, by causing a further deformation (enlargement), there may end up being irreversible damage and even, in particularly critical situations, breakage, resulting in high defectiveness of the process.

### SUMMARY OF THE INVENTION

The technical task of the present invention is therefore to improve the state of the art, by devising a device and a method for expanding tubes that make it possible to eliminate the aforementioned drawbacks.

In such a technical task, a purpose of the present invention it is devise a device and a method that make it possible to carry out the expansion of tubes in a controlled manner, and keeping the predetermined length, without locking the ends of the tubes themselves with clamps, jaws or other similar members potentially able to damage the ends themselves.

This task and this purpose are accomplished by a device and a method for expanding tubes according to the present principles.

According to an aspect of the present invention, during the enlarging operation of the diameter of the tubes, the ends of the tubes themselves, enlarged in advance to form cups, are held by end support elements that prevent the axial contraction of the tubes themselves.

In this way, the lengths of the expanded tubes are determined with precision without the previously enlarged ends being in any way deformed or damaged. Further advantageous characteristics are described in the dependent claims.

### BRIEF DESCRIPTION OF THE DRAWINGS

The characteristics of the invention will become clearer to any man skilled in the art from the following description and from the attached tables of drawings, given as a non-limiting example, in which:

FIGS. 1-7 are partially sectioned side views of successive expansion steps of the straight tubes of a heat exchanger, according to the present invention;

FIGS. 8-14 are partially sectioned side views of successive expansion steps of the tubes bent into hairpins of a heat exchanger, according to another embodiment of the present invention;

FIG. 15 is a detailed section of another embodiment of the device according to the present invention, in an expansion step;

FIG. 16 is a partially sectioned side view of an expansion step of the straight tubes, in particular with expansion under thrusting force; and

FIG. 17 is a partially sectioned side view of an expansion step of the tubes bent into hairpins, in particular with expansion under thrusting force.

### DETAILED DESCRIPTION OF EMBODIMENTS

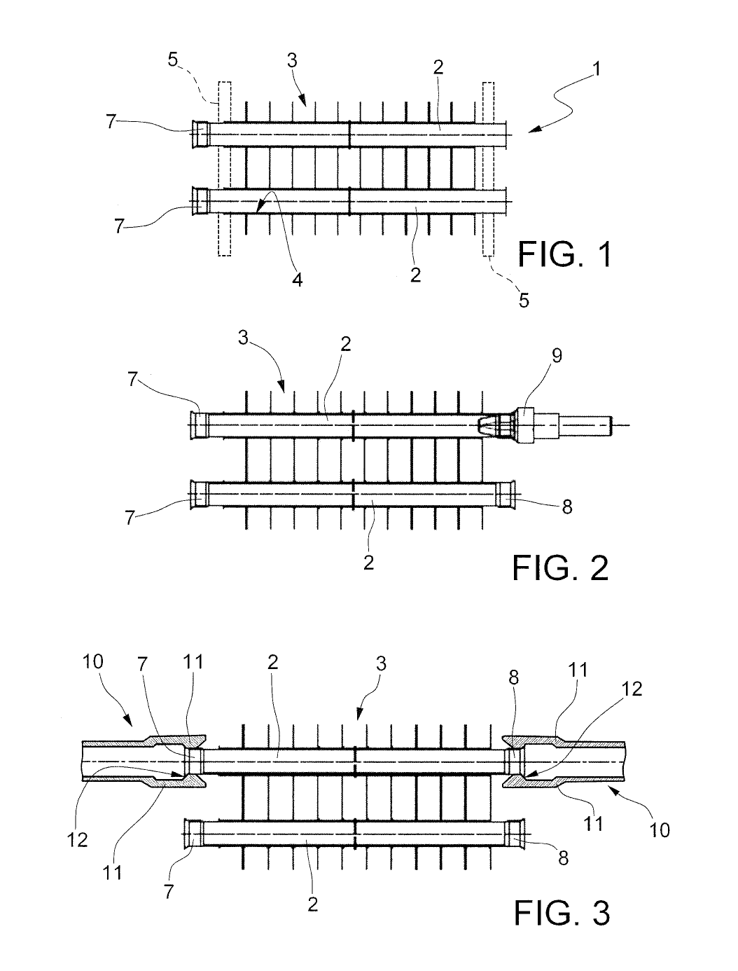

With reference to the attached FIG. 1, a heat exchanger comprising a bank of tubes 2 inserted in a finned pack 3, intended to undergo the expansion operation through the device and the method according to the present invention, is wholly indicated with 1.

In a known way, the finned pack 3 comprises holes 4 in which the tubes 2 are inserted.

It should first be stated that the expanding device of the tubes according to the present invention comprises known components—support structures, actuation means—present in all machines of this type belonging to the state of the art, and that therefore will not be described any further apart from the characteristics of interest for the purposes of the description of the present invention.

The device comprises, in a per se known way, support means 5 of the finned pack 3.

The support means 5 of the finned pack 3 are indicated with a broken line in FIG. 1, and they comprise, for example, a metallic frame.

The metallic frame supports the finned pack 3, for example, at at least two sides.

Alternatively, there can be support means 5 of the finned pack 3 having another structure or another configuration, without any limitation for the purposes of the present invention.

The device according to the invention also comprises an enlarging tool 6 of the ends 7,8 of each one of the tubes 2.

The enlarging tool 6 can be of the type known in the field, preferably of the rotary type suitable for exerting modest loads on the ends 7,8 of each one of the tubes 2.

Alternatively, any other type of enlarging tool can be used, for example of the mechanical type with radial action, or mechanical, pneumatic or electrical with axial action.

The enlarging tool 6 is associated with respective actuation means—for example electrical—foreseen in the device according to the invention and not represented, since they are of the type essentially known in the field.

It should be noted that the expanding device according to the invention can comprise a plurality of enlarging tools 6 that can work for example in parallel, i.e. simultaneously, in relation to the specific requirements of application and production.

The device according to the invention also comprises a mandrel, wholly indicated with 9, for the radial expansion, under pulling or pushing, of each one of the tubes 2, the characteristics of which will be described more clearly hereafter.

As stated for the expanding tool 6, the device according to the invention can also comprise a plurality of mandrels 9 that work in parallel, in relation to the specific requirements of application and production.

According to an aspect of the present invention, the expanding device comprises axial abutment means 10 for both ends 7,8—enlarged by the enlarging tool 6—of each one of the tubes 2 in the contraction direction of the tube 2 itself during the radial expansion or enlarging operation.

The axial abutment means 10 for the enlarged ends 7,8 prevent the contraction of the tube 2 subjected to expansion, whereas they do not prevent movement in the opposite direction, as will become clearer hereafter. Thanks to this characteristic, the axial constraint of each tube 2 is made during enlargement to prevent its contraction, without however gripping or clamping the ends 7,8 with members such as clamps, jaws and the like that can potentially strain harden, deform or damage the ends themselves.

The aforementioned axial abutment means 10 comprise, for each enlarged end 7,8 of each one of the tubes 2, end shaped elements 11.

The end shaped elements 11 are opposite one another along the axis of the tube 2 to be expanded, and they are provided with respective flared surfaces 12 suitable for matching the respective outer surfaces of the enlarged ends 7,8.

There can be any number of end shaped elements 11, for example one, two or more, in relation to the specific requirements, to the dimensions of the tubes 2, etc., so as to obtain the optimal abutment of the outer surfaces of the enlarged ends 7,8, suitably distributing the contact pressures so as not to cause localised deformations.

In greater detail, the end shaped elements 11 are each mobile, from a closed position, of axial constraint—represented in FIGS. 3-6—of the respective tube 2 to an open position, not represented in the figures.

The end shaped elements 11 are associated—for example articulated, or in another way—with actuation means, for example electric, oil-hydraulic, or similar, not represented in the figures but of the type per se known in the field.

In one embodiment, and as can be seen in FIGS. 3-6, the end shaped elements 11 are configured substantially like sorts of clamps that wrap around the outside of the enlarged ends 7,8 without however exerting any clamping force.

The enlarged ends 7,8 thus match the flared surfaces 12 in the closed position.

In other embodiments, the end shaped elements 11 can nevertheless have a different configuration, for example annular, or similar, without any limitation for the purposes of the present invention.

The mandrel 9, as stated, is of the type operating under pulling force.

In other embodiments of the present invention, however, the mandrel 9 could, with a constructive solution suitably modified for the purpose, be of the type operating under thrusting force.

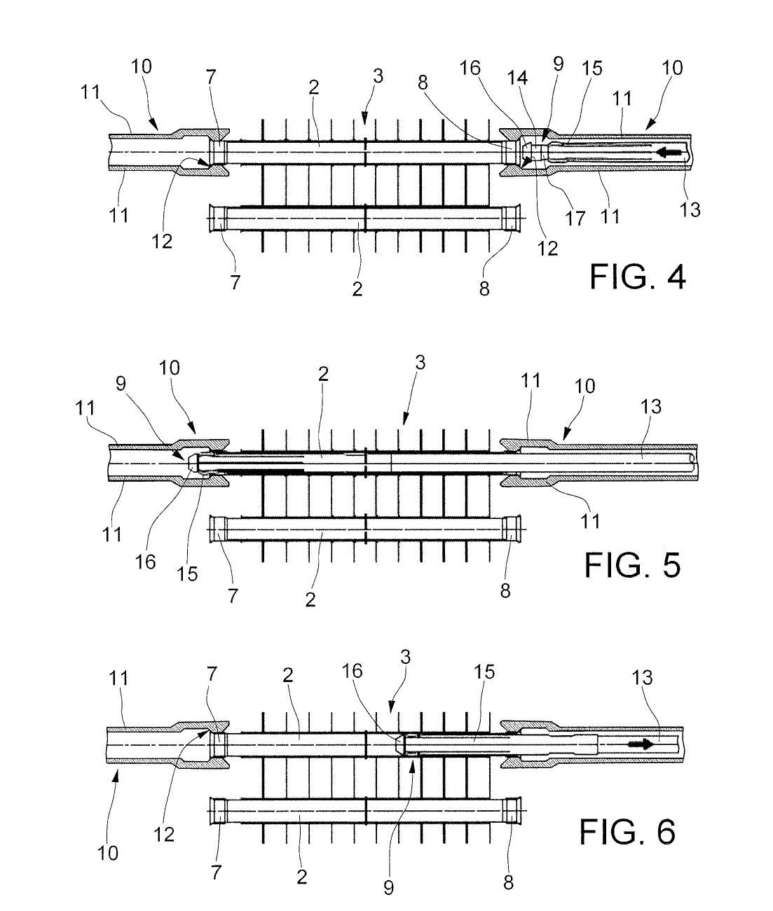

As illustrated in FIGS. 4-6, the mandrel 9 comprises a pawl-holding rod 13, an end pawl 14 integral with the rod 13 and a hollow flap expander 15, able to slide along the rod 13.

The pawl-holding rod 13 is associated with relative actuation means, not represented in the figures, which allow the insertion and extraction thereof inside the tubes 2 or the rectilinear portions of the tubes, in the case of tubes curved in a “U”, as made clear hereafter.

The actuation means of the pawl-holding rod 13 can be of the electric, oil-hydraulic or similar type. The end pawl 14 comprises a head 16, which acts as a stop, and a frusto-conical portion 17, which allows the flaps of the expander 15 to be opened out.

The expander 15 is able to slide along the pawl-holding rod 13 from a resting position, visible in FIG. 4, in which it is retracted with respect to the head 16 and its outer diameter is smaller than the outer diameter of the end pawl 14, to an expanding position, visible in FIGS. 5,6, in which the head 16 of the pawl 14 abuts on the expander 15 determining the opening out of the flaps: in this way the expander 15 takes on an outer diameter that is greater than the outer diameter of the pawl 14 and greater than the inner diameter of the tube 2 to be expanded.

The method for expanding tubes 2 carried out with the device according to the invention is described hereafter.

In an initial step of the method, the enlargement of a first end 7 of the tubes 2 is carried out, through the enlarging tool 6, for example directly in output from the machine for straightening and cutting the tubes.

The tubes 2 are then inserted into the finned pack 3, according to FIG. 1.

In a subsequent step, the enlargement of the second ends 8 of the tubes 2, inserted in the finned pack 3, is carried out, again with the enlarging tool 6, as illustrated in FIG. 2.

The enlargement of the ends 7,8 of the tubes makes it possible to make what in the field are called cups, i.e. the connection ends, for example through brazing, with other circuit elements that make up the heat exchanger, and which must be free from deformations or breakages to carry out the subsequent operations to complete the heat exchanger with optimal quality.

In a subsequent step, the ends 7,8 enlarged by the enlarging tool 6 are axially constrained, in the direction of natural contraction after expansion.

This axial constraint step is carried out by clamping the end shaped elements 11 so that their flared surfaces 12 match the outer surfaces of the enlarged ends 7,8 of the tubes 2, as illustrated in FIG. 3.

In this situation, the tubes 2 cannot undergo any axial contraction, and thus maintain the predetermined length that must be made in the end product; at the same time, the ends 7,8 are simply rested on the flared surfaces 12, without undergoing any locking with clamps, jaws or similar, and therefore without running any risk of deformation or breakage.

Thereafter, the method foresees a step of expanding each tube 2 under pulling force.

In this step, in each tube 2 the mandrel 9—or many mandrels operating in parallel—is inserted with the expander 15 in resting position, and therefore with the outer diameter smaller than the inner diameter of the tube 2.

The mandrel 9 is inserted into each tube 2 at least until it goes past the metallic frame present at the end of the finned pack opposite the insertion end 8, as illustrated in FIG. 5.

Thereafter, the expansion foresees a step of returning the pawl-holding rod 13 until the head 16 of the pawl 14 is brought into abutment on the expander 15, so that the flaps open out and the expander 15 itself takes on the expanding position.

As stated, in this condition the outer diameter of the expander 15 is greater than the inner diameter of the tube 2, and therefore the translation of the mandrel 9 backwards, as illustrated in FIG. 6, until the mandrel 9 itself is extracted from the tube 2, determines the desired radial expansion thereof, without axial contraction.

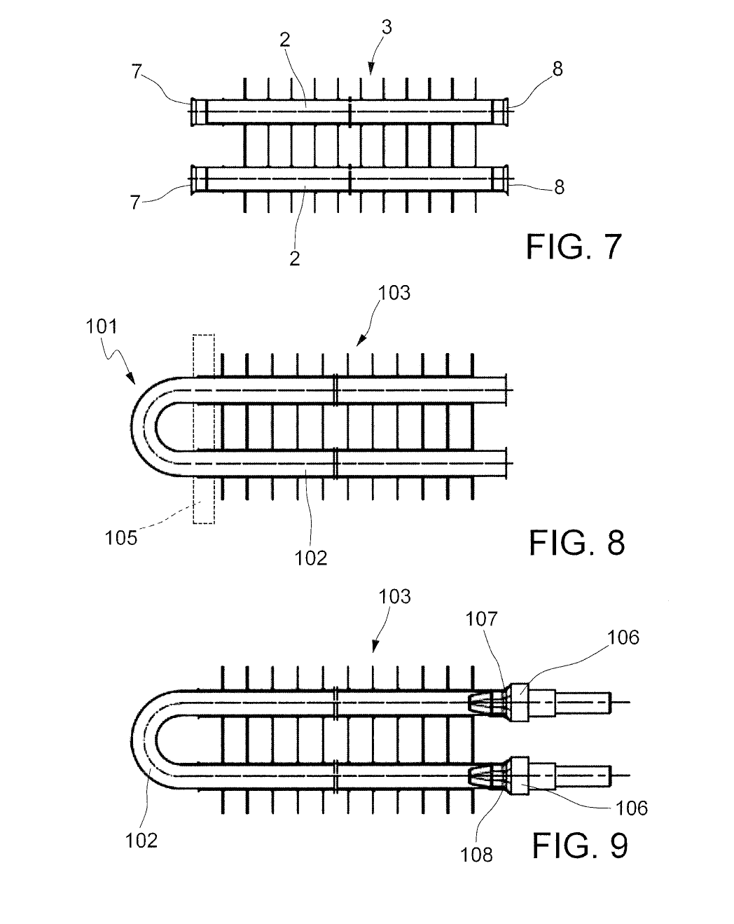

At this point, the end shaped elements 11 are opened to extract the heat exchanger 1 with the expanded tubes 2, as illustrated in FIG. 7.

As stated, the described method can also be carried out by foreseeing that the expansion is carried out under pushing force.

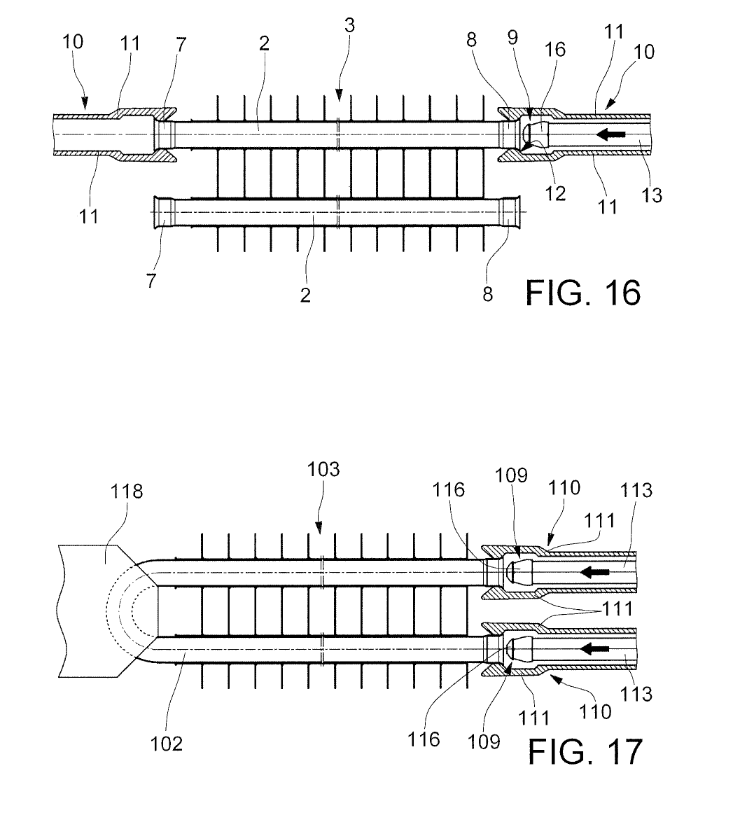

This situation is illustrated in FIG. 16.

In this last case, the contact surface of the mandrel 9, i.e. its head 16, has the outer diameter greater than that of the inner diameter of the tube 2; the insertion of the mandrel 9 in the entry end of the tube 2 causes its expansion, which proceeds during the entire translation of the mandrel 9 up to the opposite end of the finned pack.

In the next step, through the rod 13, the return of the mandrel 9 is activated, inside the tube 2, up to the resting position beyond its enlarged end 8. The invention, thus conceived, allows important technical advantages to be obtained.

As stated, the expansion of the tubes 2 can be carried out without axial contraction and therefore with a final length that is predetermined and controlled with precision, avoiding any risk of deformation or breakage, during the expansion itself, of the enlarged ends 7,8 of the tubes 2, and therefore providing the heat exchanger with optimal quality characteristics to then be subjected to the successive machining.

This process also makes it possible to carry out the enlargement operations of the ends 7,8 of the tubes 2, i.e. making the so-called cups, before the initial expansion steps, thus in a quicker and easier manner and with enlarging tools 6 that cause fairly modest axial loads. Indeed, the device and the method according to the invention ensure that the enlarged ends 7,8 will not be deformed or broken in the successive production steps, as shown above.

Furthermore, the axial constraint of the tubes 2 during expansion is carried out by providing simple flared surfaces 12 foreseen in the end shaped elements 11, and therefore it is not necessary to foresee complex and expensive clamping members like clamps, jaws, and the like.

In the described embodiment, the expansion is advantageously carried out under pulling force, and this makes it possible to more accurately control, from the side at which the pulling force occurs, the phenomena of deformation that each tube 2 undergoes during the expansion itself.

As stated, however, the expansion could also be carried out under pushing force.

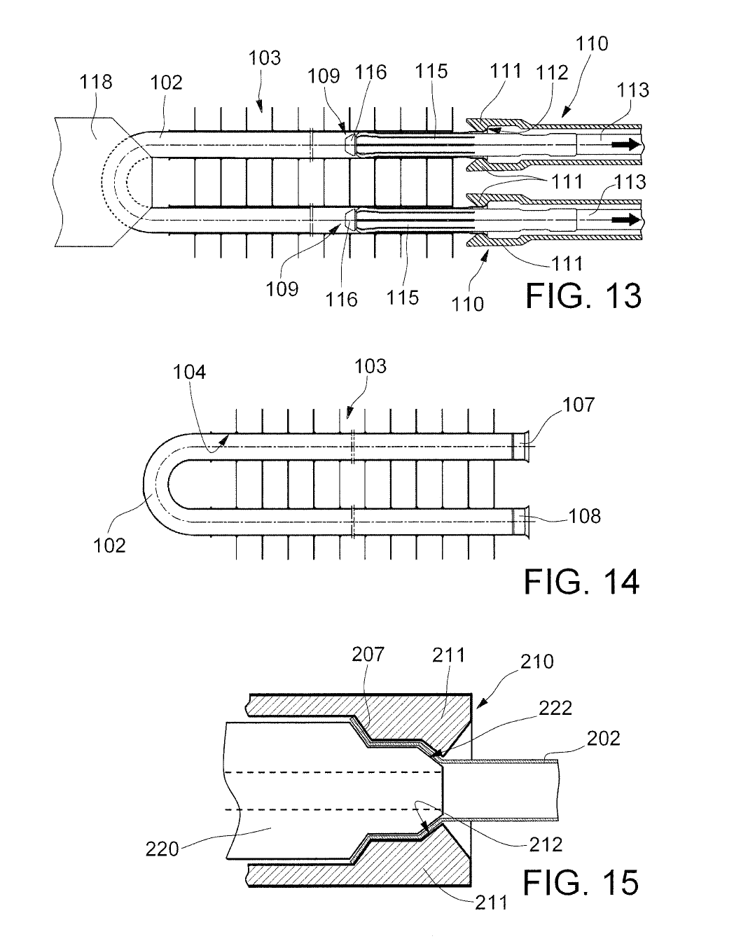

Another embodiment of the device and of the method according to the invention is illustrated in FIGS. 8-14.

In FIGS. 8-14 the same reference numerals as the previous embodiment are used, increased by 100, to indicate the corresponding elements.

This embodiment is relative to a heat exchanger 101 comprising tubes 102 bent at 180°, also known as hairpins in the field, inserted in holes 104 in the finned pack 103.

The device according to the present embodiment comprises, as described earlier, support means of the finned pack 105, a tool 106 for enlarging the ends 107,108 of each one of the tubes 102, a mandrel 109 for the radial expansion under pulling force of each one of the tubes 102, and axial abutment means 110 for both enlarged ends 107,108 of each one of the tubes 102 in the contraction direction of each one of the tubes themselves during the radial expansion operation.

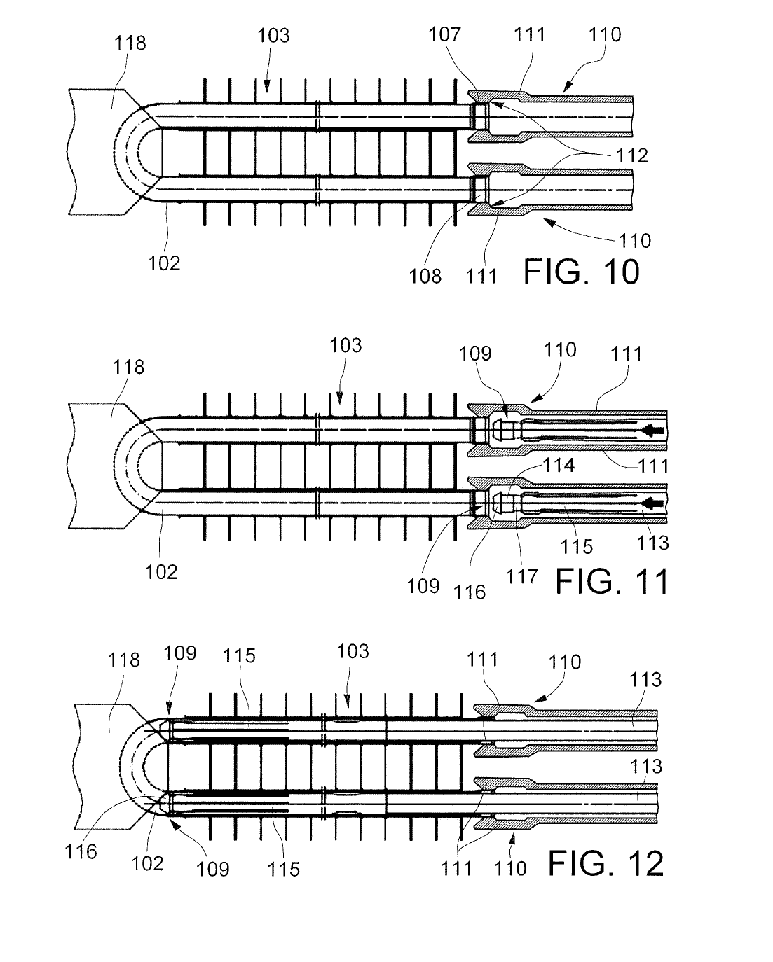

In this embodiment, the end shaped elements ill of the axial abutment means 110 are arranged adjacent to each other and not opposite, as illustrated in FIGS. 10, 13, so as to lock onto the adjacent ends 107,108 of the tubes 102 bent at 180°, or hairpins.

The mandrel 109—or the plurality of mandrels—is the same as described for the previous embodiment.

In this embodiment the expanding device also comprises an intermediate locking element 118 for the elbow portion of each tube 102, as illustrated in the same FIGS. 10-13.

The expansion method in this embodiment comprises the same steps described for the previous embodiment, apart from the fact that the enlargement of the ends 107,108 with the enlarging tool 106 is carried out with the tubes 102 already inserted in the finned pack 103, for example with a single enlarging tool 106 or with many enlarging tools 106.

Moreover, at least two mandrels 109 can be provided in the radial expansion step of the tubes 102, which operate in parallel, as illustrated in FIGS. 11-13.

Alternatively, the expansion of the two rectilinear portions of each one of the tubes 102 can be carried out one at a time, with the same mandrel 109.

In particular, by carrying out both the expansion under pulling and pushing force, it does not matter whether a single arm is expanded or both arms precisely because the process takes place without variation of the length of the single arms of the hairpin tube 102: this means that the hairpin tube 102 can cover, in the finned pack, the same line—presuming that the operating axis of the device is horizontal—but it could also cover two lines vertically, i.e. with aligned tubes, or diagonally, i.e. with tubes offset. Moreover, the method foresees, in addition to what is described according to the previous embodiment, an actuation step of the intermediate locking element 118, which is operated, to open and close, simultaneously with the end shaped elements 11.

In this embodiment, therefore, tubes 102 bent at 180°, or hairpins, are expanded, achieving the same advantages described for the previous embodiment. FIG. 17 represents an expansion step of the tubes 102 bent into hairpins, in particular with expansion under thrusting force.

The expansion in this case takes place in a totally analogous way to what is described for the situation of FIG. 16 with straight tubes.

Another embodiment of the device according to the invention is illustrated in the detailed section of FIG. 15.

In this embodiment, the axial abutment means 210 comprise, as well as end shaped elements 211 with the respective flared surfaces 212 of the type described in the previous embodiments, a shaped counter element 220 comprising flared surfaces 222 that internally abut on the corresponding flared surfaces of the enlarged ends 207 of the tube 202 to be expanded, without however exerting any pressure such as to deform or strain harden said enlarged ends 207.

The presence of such a shaped counter element 220 constitutes a further locking constraint of the enlarged ends during the expansion operation, for example in particularly critical situations.

It has thus been seen how the invention achieves the proposed purposes.

The present invention has been described according to preferred embodiments, but equivalent variants can be conceived without departing from the scope of protection offered by the following claims.

1. Device for expanding tubes inserted in a finned pack of a heat exchanger, comprising:
support means of the finned pack;
a tool for enlarging the ends of each one of the tubes;
a mandrel for the radial expansion of each of the tubes; and
axial abutment means for both enlarged ends of each of the tubes along the contraction direction of each of the tubes during the radial expansion operation.

2. Device according to claim 1, wherein said axial abutment means comprise, for each enlarged end of each of the tubes, end shaped elements provided with respective flared surfaces matching with the respective outer surfaces of the enlarged ends.

3. Device according to claim 2, wherein said end shaped elements are arranged opposite to one another along the axis of the tube to be expanded.

4. Device according to claim 2, wherein said end shaped elements are arranged adjacent to each other.

5. Device according to claim 2, wherein said end shaped elements are movable from a closed axial abutment position of the respective tube to an open position.

6. Device according to claim 1, further comprising an intermediate locking element for an elbow portion of each tube.

7. Device according to claim 1, wherein said mandrel comprises a pawl-holding rod, an end pawl integral with said rod and an expander able to slide along said rod, said expander being able to slide along said rod from a resting position, in which said expander is retracted and its outer diameter is smaller than the inner diameter of the tube, to an expanding position, in which said expander abuts on the pawl and has an outer diameter greater than the inner diameter of the tube to be expanded.

8. Device according to claim 2, wherein said axial abutment means comprise, for each enlarged end of each of the tubes, an end shaped counter element provided with respective flared surfaces matching with the respective inner surfaces of the enlarged ends.

9. Method for expanding tubes, inserted in a finned pack of a heat exchanger, carried out using the expanding device according to claim 1, comprising the steps of:
enlarging the ends of each of the tubes;
axially constraining the enlarged ends of each of the tubes in the contraction direction;
expanding each tube or each rectilinear portion of each tube.

10. Method according to claim 9, wherein said step of axially constraining the enlarged ends of each of the tubes in the contraction direction comprises closing said end shaped elements abutting on the respective outer surfaces of the enlarged ends.

11. Method according to claim 9, wherein said step of expanding each tube or each rectilinear portion of each tube is carried out under pulling force and comprises a step of inserting in each tube or in each rectilinear portion of each tube said mandrel with said expander being in a resting position and with the outer diameter thereof being smaller than the inner diameter of the tube.

12. Method according to claim 11, wherein said step of expanding under pulling force said tube or each rectilinear portion of said tube comprises a step of returning said pawl-holding rod thus resulting in the enlargement of said expander in expanding position so as to take on an outer diameter greater than the inner diameter of the tube, up to extracting said mandrel from the tube.

13. Method according to claim 9, comprising a step of opening said end shaped elements to extract the heat exchanger with tubes expanded.

14. Method according to claim 9, further comprising the steps of locking and subsequently opening again an intermediate locking element on an elbow portion of each tube.

15. Method according to claim 9, wherein said step of enlarging the ends of the tubes comprises enlarging a first end of the tubes after the operation of cutting and straightening the tubes, and enlarging the second end of the tubes with the tubes being inserted in the finned pack.

16. Method according to claim 9, wherein said step of enlarging the ends of the tubes is carried out while the tubes are inserted in the finned pack.
